(19) United States
(12) Patent Application Publication
(10) Pub. No.: US 2019/0016526 A1
(43) Pub. Date: Jan. 17, 2019

(54) CANDY IN ORIGINAL PACKAGE

(71) Applicant: Grand Candy, Yerevan (AM)

(72) Inventor: Karen Vardanyan Hrant, Yerevan (AM)

(21) Appl. No.: 16/037,028

(22) Filed: Jul. 17, 2018

(30) Foreign Application Priority Data
Jul. 17, 2017 (RU) 2017125473

(51) Int. Cl. B65D 85/60; B65D 65/18; A23G 3/54

(52) U.S. Cl. CPC B65D 85/60; A23G 3/343; A23G 3/545; B65D 65/18

(57) ABSTRACT

Production of confectionery products, namely candies having various fillings, preferably chocolate, caramel, jelly, other fillings. Wrap decoration operations are reduced and by using shapes and colors of the wrapped candy as a base for the image on the wrap, reducing material consumption. Accurate alignment of the candy and the image fragments improves the composite image. The body is covered with a glaze coating and wrapped with a transparent material, having a stylized image, the side face and the end faces of the wrap being connected. The wrap includes inner and outer layers. The inside of the outer layer and/or the outside of the inner layer comprises colored image fragments that make up the stylized image on the wrap. The candy body can be ball-shaped, presenting a three-dimensional configuration on the wrap. The body glaze coating forms can provide color to the wrap stylized image. The joint strength of the wrap ends is lower than that of its side face. The wrap can be opened from its end face by applying pressure to the wrap and removing the candy body from the end face by holding the outer surface of the wrap.

### RELATED APPLICATION

The present application claims priority to Russian Application No. 2017125473 filed Jul. 17, 2017, which is hereby incorporated herein in its entirety by reference, including the English translation thereof.

### TECHNICAL FIELD

The present invention generally relates to the food industry, and in particular to the confectionery industry, and can be used for production of confectionery products having various fillings, including chocolate filling.

### BACKGROUND

Different solutions for confections are known from the prior art; Russian patent publication RU2568564, IPC B65D5/42, published on 20 Nov. 2015 discloses a food package containing a food product, in the form of a candy wrap with a candy inside of it.

A food package with a shaped chocolate inside is known from German utility model DE1947463, published in 1966. DE1947463 discloses a food package and a shaped candy representing a “bunny” or “Santa Claus” figure, wherein the food package is made of a transparent solid material, ornamented with complete and stylized depictions of plants, decorations, flowers, and other similar decor elements. The shaped candy in the form of a “bunny” or “Santa Claus” is freely placed inside the package and is held in place by the sealed ends of the food package. The shaped candy combines with the decor elements on the food package to form an overall appearance.

Drawbacks of known solutions include a complicated manufacturing process, an inability to use shapes and colors of the wrapped candy as a base for shapes and colors of the image on the food package due to misalignment between the candy and the food package, and, accordingly, increased printing material consumption necessary to create an image on the food package. Another drawback is that a candy can't be consumed without touching it when unwrapping.

An object of the present invention is to simplify the manufacturing process by reducing the number of food package decoration operations, such as printing and/or painting operations, by using the shapes and colors of the wrapped candy as a base for shapes and colors of the image on the food package, and consequently to reduce paint or printing ink consumption required to create an image on the food package. Other objects of the present invention are to improve the quality of the final stylized composite image by means of more exact alignment of the candy and the image fragments depicted on the food package, and to improve the hygienic properties of candy consumption.

### SUMMARY OF THE INVENTION

In accordance with one aspect of this invention, there is provided a candy comprising a ball-shaped candy body made from a candy mass and covered with a sugar glaze coating with the thickness of 0.5-2.5 mm; a wrap produced of a transparent material having a stylized image thereon in which the said candy body is wrapped by connecting the side face and the end faces of the wrap; wherein the wrap comprises two transparent layers—an inner layer and an outer layer; on the inside of the outer layer and/or on the outside of the inner layer image fragments are printed and colored at least in one color and having a shape and dimensions corresponding to the respective fragments of the stylized image on the wrap; wherein the candy body is intended to create a three-dimensional configuration of the stylized image on the wrap, and a color of the glaze coating of the candy body forms a part of the color of the stylized image on the wrap, wherein the joint strength of the end faces of the wrap is lower than that of the side face, so as the wrap can be opened from its end face by applying pressure to the wrap and removing the candy body from the end face by holding the outer surface of the wrap.

There are also other possible embodiments of the invention where it is desired:
to use two candy bodies,
to use three candy bodies,
to connect the side face and the end faces of the wrap by heat sealing and to serrate end faces by cutting,
to make the wrap inner and outer layers of transparent films.

Other features and aspects of this invention will be apparent from the following description and the accompanying drawings.

### BRIEF DESCRIPTION OF THE DRAWINGS

Embodiments of the invention will now be described with reference to the accompanying drawings, in which:

FIG. 1 shows a flat wrap pattern.

FIG. 2 shows a top view of FIG. 1.

FIG. 3 shows a side view of FIG. 1.

FIG. 4 shows a sectional view of a candy body.

FIG. 5 shows a front-side view of the composition with one ball-shaped candy body.

FIG. 6 shows a rear-side view of the composition with one ball-shaped candy body.

FIG. 7 shows a flat wrap pattern for two candy bodies.

FIG. 8 shows a front-side view of the composition with two ball-shaped candies.

FIG. 9 shows a rear-side view of the composition with two ball-shaped candy bodies.

FIG. 10 shows a flat wrap pattern for three candy bodies.

FIG. 11 shows a front-side view of the composition with three ball-shaped candy bodies.

FIG. 12 shows a rear-side view of the composition with three ball-shaped candy bodies.

FIG. 13 shows examples of composing a candy according to the present invention.

### DETAILED DESCRIPTION

The present invention is illustrated by specific embodiments shown on the figures which, however, are not intended to be exhaustive, but clearly demonstrate how the desired technical effect can be achieved with the claimed set of features.

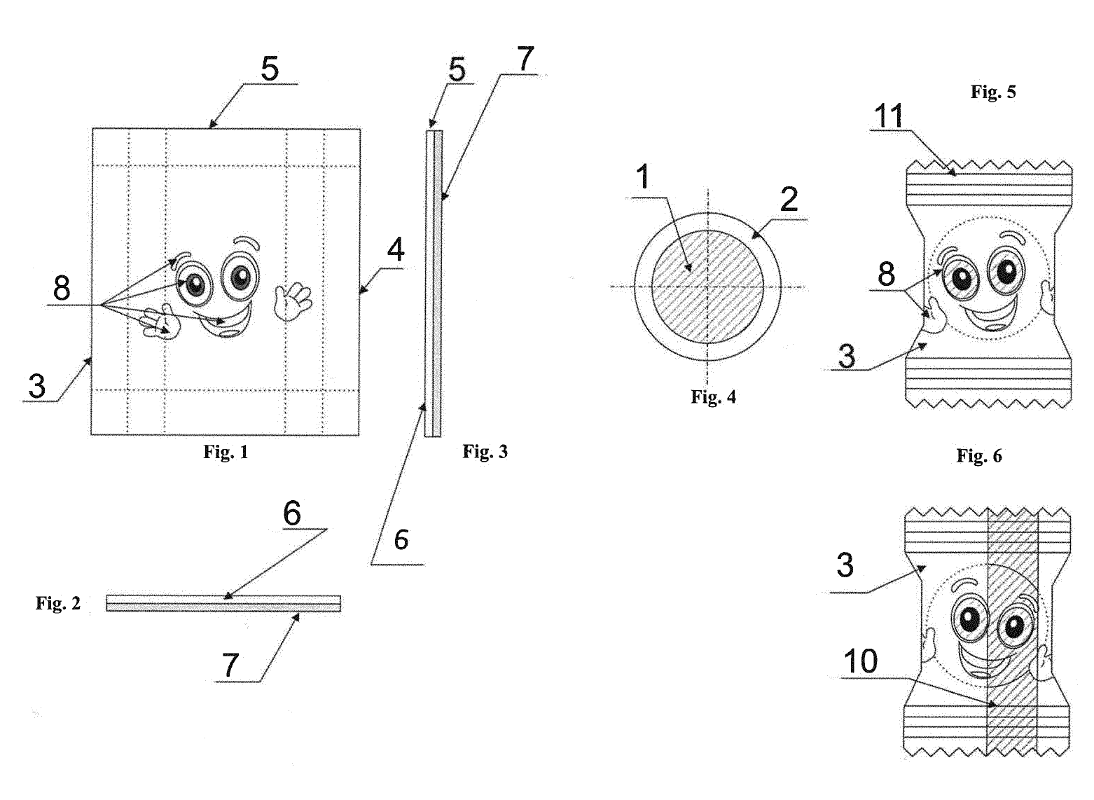

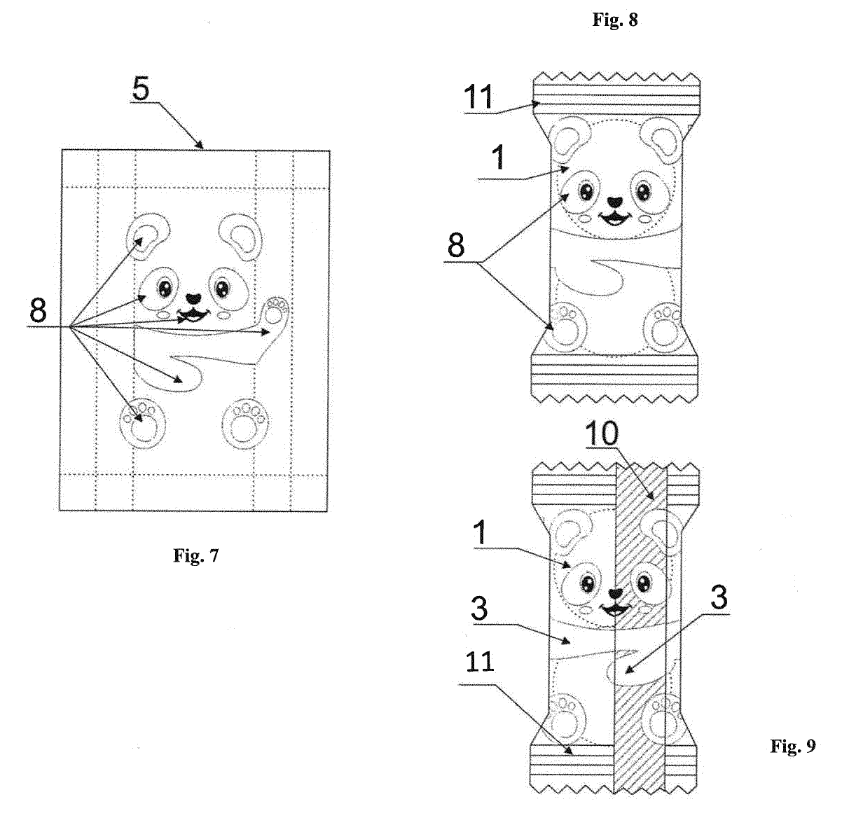

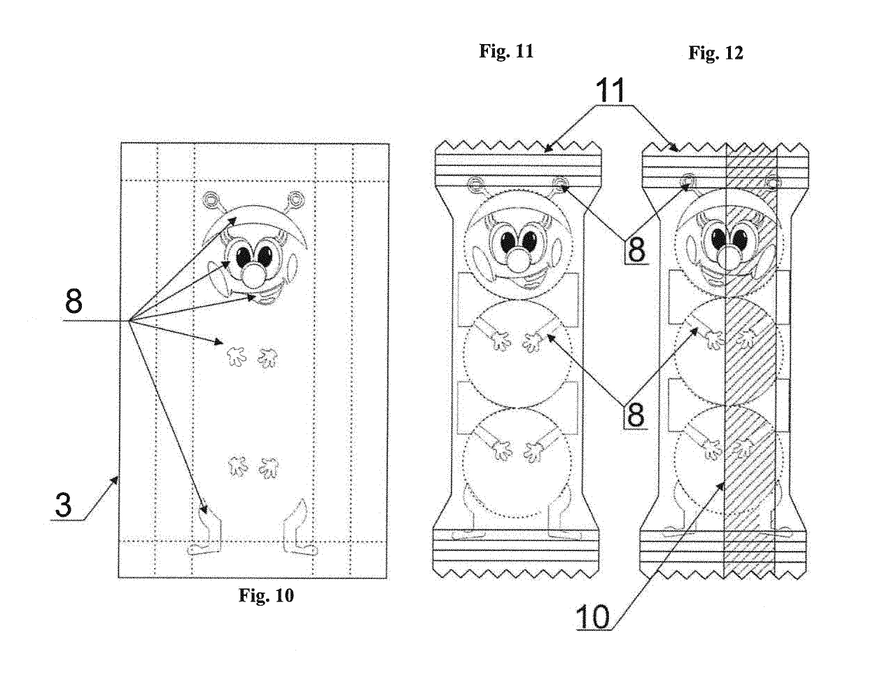

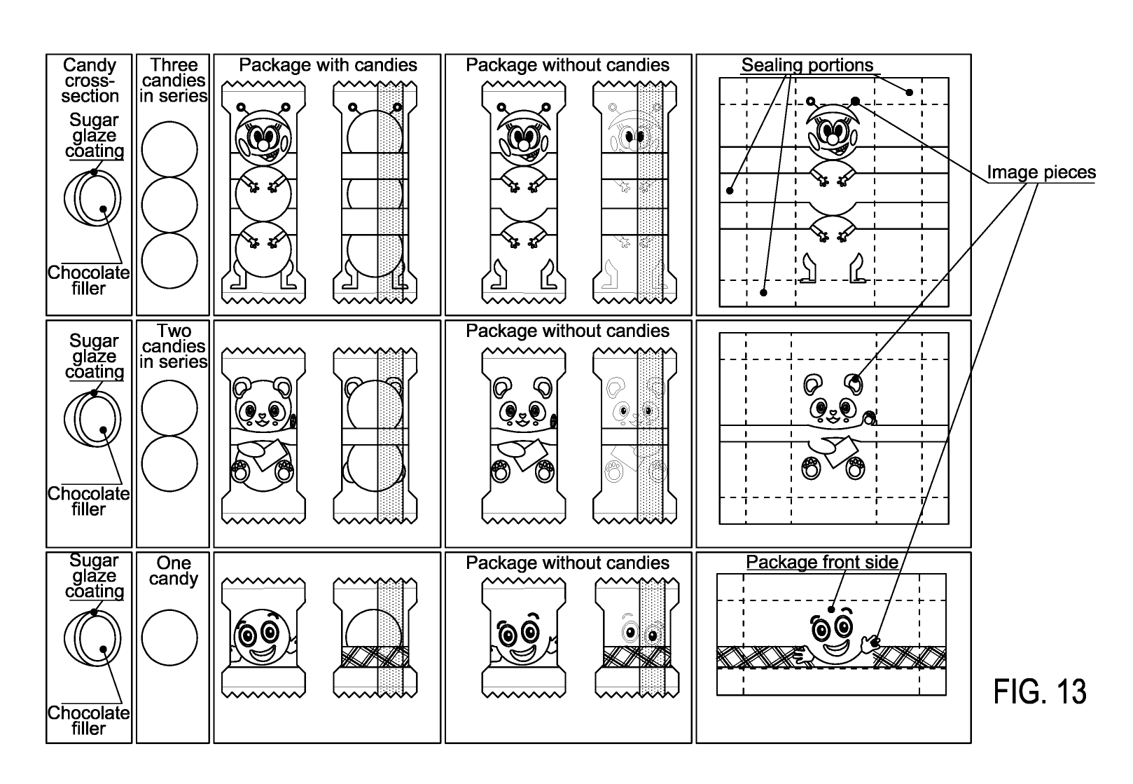

According to the invention (FIGS. 1-13), a candy comprises a candy body 1 which is a candy mass of a desired shape and covered with a glaze coating 2. The candy body 1 may be formed of chocolate. A food package in the form of a wrap 3 is made of a transparent material in which the candy body 1 is wrapped by connecting a side face 4 and end face 5 of the wrap 3. The wrap 3 consists of two layers 6, 7, namely an inner layer and an outer layer, respectively. At least one image fragment 8 is formed on the inside of the outer layer 7 and/or on the outside of the inner layer 6, each image fragment 8 being colored in at least one color and having a shape and dimension to form respective fragments of a stylized image on the wrap 3. At least one candy body 1 is used which is made ball-shaped and is intended to create a three-dimensional configuration of the stylized image on the wrap 3. The color of the glaze coating 2 of the candy body 1 is visible through the transparent material and forms a part of the color of the stylized image on the wrap 3. This color part can be the base of the stylized image.

The end faces 5 of the wrap are formed with a lower joint strength than that of the side faces 4, so the wrap 3 can be opened from the end face 5 by applying pressure to the wrap 3 and removing the candy body 1 from the end face 5 while holding the outer surface of the wrap 3.

The described embodiment of the invention makes it possible to reduce the number of printing/painting operations and the quantity of coloring material such as printing ink or paint. In addition, placing image fragments between the inner and outer layers 6, 7 inside the wrap 3 prevents the coloring material from coming into contact with the candy or the consumer when consuming the candy.

In embodiments of this invention it may be desirable to form a product in the likeness of a fairy-tale character or various animals' figures. To achieve this, one, two or three ball-shaped candy bodies 1 can be used and covered with a (sugar) glaze coating 2 having a thickness in the range between 0.5 to 2.5 mm, which is specified by organoleptic properties of the candy taking into account strength properties of the candy mass or chocolate and/or filling 9. The lower thickness limit of the glaze coating 2 is determined by the requirement to retain the shape of the candy, while the upper limit of the glaze coating 2 is determined by candy taste properties. A glaze coating 2 with a thickness below 0.5 mm may hinder ball-shape retention during a long period of storage, while a thickness above 2.5 mm may cause a taste imbalance between the glaze coating and the candy mass and/or chocolate forming the candy body 1.

The said stylized image fragments 8 are placed on the inside of the outer layer 7 and/or the outside of the inner layer 6 by printing or painting, such that the printing or painting does not come into contact with the candy.

The joint strength of the wrap end faces 5 is lower than that of its side face 4. As a result of such configuration, the wrap 3 can be opened by applying pressure to the candy and removing the candy body 1 from the end faces 5 without touching it with fingers, as if pressing it out, for example, pulling the candy with teeth without contacting the coloring material such as printing ink or paint.

The side and end faces 4, 5 of the wrap 3 are joined by heat sealing, and the end faces 5 are serrated by means of cutting, which aids in easily removing the candy from the wrap 3.

To maintain high organoleptic properties of candy for longer service life, the inner layer 6 and the outer layer 7 of the wrap 3 are made of transparent film.

### Example of Embodiment of the Invention

At first, a two-layered wrap 3 is formed, wherein on the inside of the outer layer and/or on the outside of the inner layer paint layers are applied to form fragments, the shape and dimensions of which correspond to those of the stylized image on the wrap 3 design; for instance, they can represent brows, eyes, a scarf or mittens, etc., which individually cannot represent a complete image of the wrap design, e.g., the image of a “Panda” bear cub, or “Roly-Poly”, or a Russian nesting doll, or any other character. These fragments are printed either single-colored, e.g., with a black paint on a transparent background or with colored paints, namely, on a transparent wrap background, the fragments have white, green, red and other colors. After that, the wrap is rolled-up by overlapping and heat-sealing side faces on the portion 10 to form a hollow space inside. One, two or three ball-shaped candy bodies 1 are placed inside this hollow space, and the quantity of candy bodies 1 is determined by the type of the final confectionery product. Due to its ball-shape, the candy body 1 can be exactly aligned with the painted fragments on the wrap 3 and for that wrap 3 portions on end faces are heat sealed, too, on the portion 11 so that the candy body 1 is fixed in the hollow space to form the final character of the design of the confectionery product. For this reason, as was mentioned above, a candy body 1 is made in the form of at least one three-dimensional element substantially in the form of a ball. The candy bodies 1 are arranged in the hollow space of the wrap 3 in series to form a stylized image of the character on the wrap, e.g., the character of “Roly-Poly”, a bear cub, or a Russian nesting doll, or a green caterpillar. For this reason, the candy body 1 is covered with a colored sugar glaze coating 2, the color of which is a base for the image on the wrap 3: e.g., for the character of “Roly-Poly” or “the Sun”, the coating is made yellow, for the character of a Russian nesting doll it is light-orange, for the character of a “Panda” bear cub it is white and for the character of a caterpillar it is green, etc.

Individually, neither the wrapped candies nor the stylized image fragments of the design on the wrap, can create a complete character. However, when the candy bodies are positioned in the wrap 3, the candy bodies 1 together with the stylized image fragments on the wrap 3 form a complete image.

As a result, a candy in an original wrap is obtained which substantially represents a 3D format toy for a specific purpose, e.g. a toy in the likeness of a favorite fairy-tale or an animated character, such as “Roly-Poly”, “the Sun”, a “Panda” bear cub, the “Snowman”, “Santa Claus”, or a toy having an educational purpose related to the insect world, in particular, the character of a green caterpillar or other characters, or in the likeness of a little man.

To increase the ease of removing the candy from the wrap and for hygienic consumption of the candy, the joint strength of the end faces of the wrap 3 is lower than that of its side faces so as the wrap 3 can be opened by applying pressure to it from the side and removing the candy from the end faces without touching it with fingers. Moreover, the multiple layers of the wrapping ensure retention of organoleptic characteristics of the candy for a long period of storage and transportation, as well as during its consumption by a consumer when he or she holds a candy in his or her hands or in a pocket of his or her clothes. In other words, such candy retains its shape and taste properties.

Possible embodiments of the confectionery product:
a candy body 1 (FIG. 5, 6) is made in the form of one ball covered with a yellow sugar glaze coating to create a stylized image of a fairy-tale character “Roly-Poly” or “the Sun”;
a candy body 1 (FIG. 8, 9) can be made in the form of two balls covered with a white sugar glaze coating to create a stylized image of a fairy-tale character “Snowman”, “Santa Claus” or stylized images of animals, such as “Panda” bear cub, or stylized image of a little man;
a candy body 1 (FIG. 11, 12) can be made in the form of three balls covered with a green sugar glaze coating to create a stylized image of a “caterpillar”.

The present invention intended for production of a candy in the form of a body 1 in a wrap 3 covered with a glaze coating 2 makes it possible to simplify manufacturing of the wrapped candy by reducing the printing/painting operations and quantity of printing ink/paint needed to form an image, and to improve significantly the hygienic properties of candy consumption.

1. A candy comprising a ball-shaped candy body made from a candy mass and covered with a sugar glaze coating with the thickness of 0.5-2.5 mm; a wrap produced of a transparent material having a stylized image thereon in which the candy body is wrapped by connecting the side face and the end faces of the wrap; wherein the wrap comprises two transparent layers—an inner layer and an outer layer; on the inside of the outer layer and/or on the outside of the inner layer image fragments are printed and colored at least in one color and having a shape and dimensions corresponding to the respective fragments of the stylized image on the wrap; wherein the candy body is intended to create a three-dimensional configuration of the stylized image on the wrap, and a color of the glaze coating of the candy body forms a part of the color of the stylized image on the wrap, wherein the joint strength of the end faces of the wrap is lower than that of the side face, so as the wrap can be opened from its end face by applying pressure to the wrap and removing the candy body from the end face by holding the outer surface of the wrap.

2. The candy in accordance with the claim 1, wherein two candy bodies are used.

3. The candy in accordance with the claim 1, wherein three candy bodies are used.

4. The candy in accordance with the claim 1, wherein the side face and the end faces of the wrap are connected by heat-sealing, wherein the end faces are serrated by means of cutting.
